(19) United States
(12) Patent Application Publication
(10) Pub. No.: US 2026/0004533 A1
(43) Pub. Date: Jan. 1, 2026

(54) USABILITY HEATMAP GENERATION FOR AUGMENTED REALITY

(71) Applicant: Niantic Spatial, Inc., San Francisco, CA (US)

(72) Inventors: Daniel Knoblauch, San Francisco, CA (US); Purna Sowmya Munukutla, Redwood City, CA (US); Krithika Govindaraj, Seattle, WA (US)

(21) Appl. No.: 19/250,957

(22) Filed: Jun. 26, 2025

Related U.S. Application Data
(60) Provisional application No. 63/666,600, filed on Jul. 1, 2024.

(51) Int. Cl. G06T 19/00; G06V 20/20; G06V 20/70

(52) U.S. Cl. CPC G06T 19/006; G06V 20/20; G06V 20/70; G06V 2201/07

(57) ABSTRACT

An online computing system generates and uses usability heatmaps to ensure that AR content is presented in suitable locations within geographic areas. To generate a usability heatmap, the online system accesses geographic data describing a geographic area for which the online system provides AR content services and identifies a set of portions of the geographic area. The online system identifies subsets of the geographic data for each of the portions of the geographic area and computes a usability score for each of the portions. The online system generates a usability heatmap based on the computed usability scores for the portions of the geographic area and stores the heatmap in a heatmap database that stores usability heatmaps for different geographic areas. The online system may use the heatmaps in the database to generate AR content when requested by client devices.

### CROSS-REFERENCE TO RELATED APPLICATIONS

This application claims the benefit of U.S. Provisional Patent Application No. 63/666,600, filed Jul. 1, 2024, which is incorporated by reference.

### BACKGROUND

### 1. Technical Field

The subject matter described relates generally to augmented reality technology, and, in particular, to improving the safety of using augmented reality technology in public settings.

### 2. Problem

Augmented reality (AR) systems provide AR content (e.g., AR gaming content) to users through applications on user client devices. Through an application, an AR system may present a user with virtual content overlaid on images of the user's real-world environment or may present the real-world environment of the user in a manner that gives the impression that virtual objects are interacting with the real-world.

However, not all locations in real-world environments are suitable for providing AR content. For example, some areas may be unsafe for users to experience AR content (e.g., while it may be safe for a user to interact with AR content in a park, it may be unsafe for the user to interact with AR content in a parking lot or on a road). Similarly, in some locations users may not be allowed or able to interact with AR content (e.g., private property, inaccessible areas, etc.). There is therefore a need for AR systems to be able to determine where in the real-world environment is suitable for users to interact with AR content such that they may avoid presenting users with content in unsuitable (e.g., unsafe) areas.

### SUMMARY

An online computing system generates and uses usability heatmaps to ensure that AR content is presented in suitable locations within geographic areas. To generate a usability heatmap, the online system accesses geographic data describing a geographic area for which the online system provides AR content services. For example, the online system may provide AR content around places of interest in the real world by storing 3D models of the places of interest and by generating AR content based on sensor data captured by client devices and the 3D models. The geographic data may include user location data (e.g., user trajectory data), semantic labels, map labels, object detection data, and user localization data.

The online system generates a usability heatmap for the geographic area based on the geographic data. To generate the usability heatmap, the online system identifies a set of portions of the geographic area. For example, these portions may be a grid of sub-areas within the geographic area. The online system identifies subsets of the geographic data for each of the portions of the geographic area and computes a usability score for each of the portions. For example, the online system may compute a frequency with which users are present within each of the portions and compute a usability score for each of the portions based on the corresponding frequencies.

The online system generates a usability heatmap based on the computed usability scores for the portions of the geographic area and stores the heatmap in a heatmap database that stores usability heatmaps for different geographic areas. The online system may use the heatmaps in the database to generate AR content when requested by client devices. For example, the usability heatmaps may align with 3D models (e.g., meshes) of geographic areas and the online system may use the usability heatmaps to place AR content within the 3D models. For example, the online system may require a threshold usability score for portions of the usability heatmap for AR content to be placed within the portions.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for generating and using usability heatmaps, according to one embodiment.

FIG. 4A shows example user trajectories overlaid on a reconstruction of a real-world environment, according to one embodiment.

FIG. 4B is an example 3D map showing detected objects surrounded by 3D bounding boxes, according to one embodiment.

FIG. 4C shows an example usability heatmap generated based on user location data and semantic data, according to one embodiment.

FIG. 5 is a flowchart describing an example method of generating usability maps for geographic areas, according to one embodiment.

FIG. 6 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where generating and using usability heatmaps is desirable. In addition, the inherent flexibility of computer-based systems allows for a great variety of possible configurations, combinations, and divisions of tasks and functionality between and among the components of the system.

### Example Location-Based Augmented Reality Application

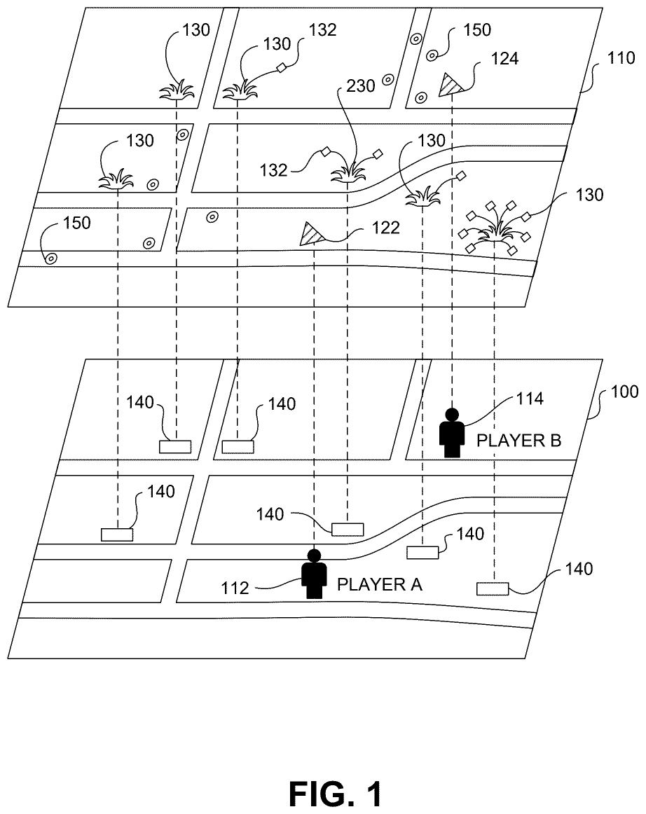

FIG. 1 is a conceptual diagram of a virtual world 110 that parallels the real world 100. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A user's position in the virtual world 110 corresponds to the user's position in the real world 100. For instance, in the example of a parallel-reality game, player A located at position 112 in the real world 100 has a corresponding position 122 in the virtual world 110. Similarly, player B located at position 114 in the real world 100 has a corresponding position 124 in the virtual world 110. As the users move about in a range of geographic coordinates in the real world 100, the users also move about in the range of coordinates defining the virtual space in the virtual world 110. In particular, a positioning system (e.g., a GPS system, a localization system, or both) associated with a mobile computing device carried by the user can be used to track a user's position as the user navigates the range of geographic coordinates in the real world 100. Data associated with the user's position in the real world 100 is used to update the user's position in the corresponding range of coordinates defining the virtual space in the virtual world 110. In this manner, users can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

In some embodiments, the virtual world 110 includes virtual objects at locations that correspond to points of interest 140 in the real world 100. The points of interest 140 can be works of art, monuments, buildings, businesses, libraries, museums, or other suitable real-world landmarks or objects. Data regarding the points of interest in the real world (e.g., photographs, text descriptions, videos, audio recording) may be aggregated and stored for use in augmented reality (AR) or other location-based functionality tied to the virtual world 110. Data regarding points of interest 140 may also include information about how users interact with the points of interest, such as user IDs or numbers of users who engage in an AR experience at the point of interest, user IDs or numbers of users who submit information about the points of interest, gameplay results at the points of interest, or any other suitable information about user activity at or near the points of interest.

In the example of a location-based game, the game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to points of interest 140 in the real world 100. The points of interest 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the points of interest 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

In some embodiments, the location-based game is a massive multi-player parallel-reality game where every participant in the game shares the same virtual world 110. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

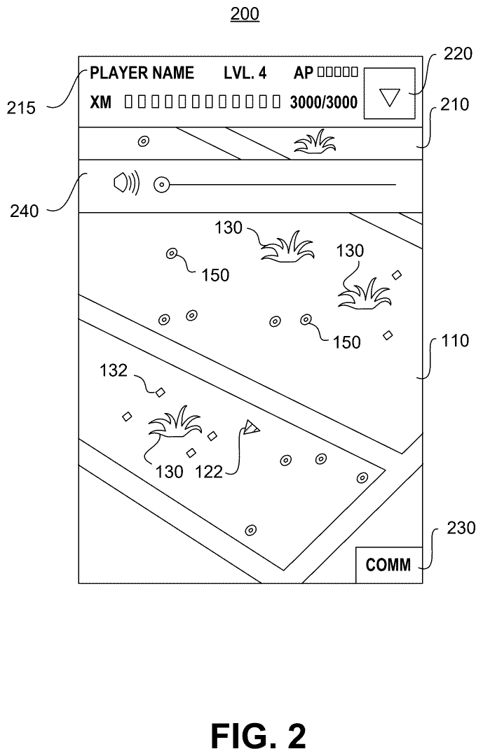

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Location-Based Application System

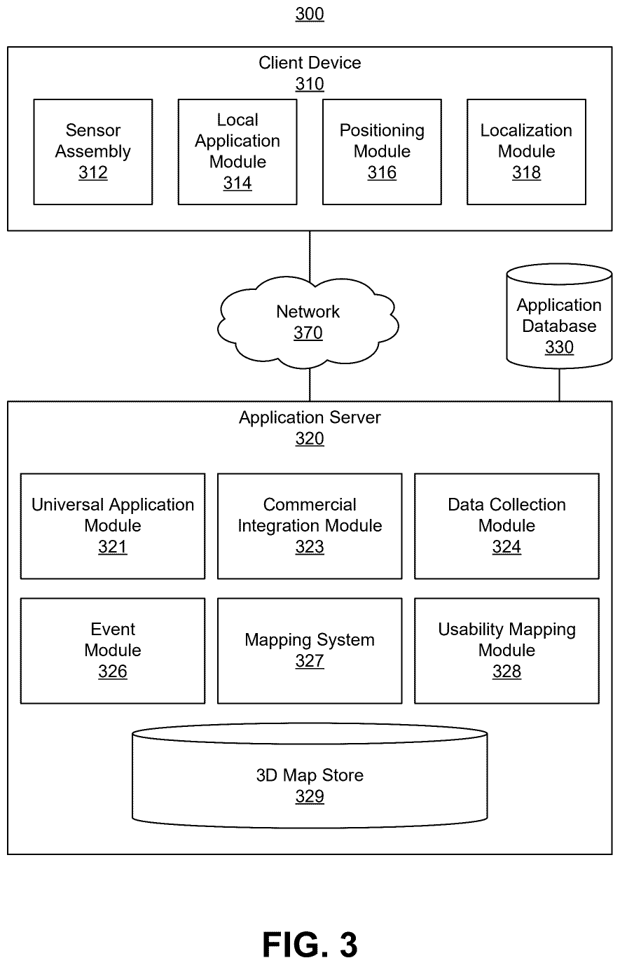

FIG. 3 illustrates one embodiment of a networked computing environment 300. The networked computing environment 300 uses a client-server architecture, where an application server 320 communicates with a client device 310 over a network 370 to provide a location-based application (e.g., a parallel reality game) to a user at the client device 310. The networked computing environment 300 also may include other external systems such as sponsor/advertiser systems or business systems. Although only one client device 310 is shown in FIG. 3, any number of client devices 310 or other external systems may be connected to the application server 320 over the network 370. Furthermore, the networked computing environment 300 may contain different or additional elements and functionality may be distributed between the client device 310 and the application server 320 in different manners than described below.

The networked computing environment 300 provides for the interaction of users in a virtual world having a geography that parallels the real world. In particular, a geographic area in the real world can be linked or mapped directly to a corresponding area in the virtual world. A player can move about in the virtual world by moving to various geographic locations in the real world. For instance, a user's position in the real world can be tracked and used to update the user's position in the virtual world. Typically, the user's position in the real world is determined by finding the location of a client device 310 through which the user is interacting with the virtual world and assuming the player is at the same (or approximately the same) location. For example, in various embodiments, the user may interact with a virtual element if the user's location in the real world is within a threshold distance (e.g., ten meters, twenty meters, etc.) of the real-world location that corresponds to the virtual location of the virtual element in the virtual world. For convenience, various embodiments are described with reference to “the user's location” but one of skill in the art will appreciate that such references may refer to the location of the user's client device 310.

A client device 310 can be any portable computing device capable for use by a user to interface with the application server 320. For instance, a client device 310 is preferably a portable wireless device that can be carried by a user, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the application server 320 to provide sensory data of a physical environment. In one embodiment, the client device 310 includes a sensor assembly 312, a local application module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The sensor assembly 312 includes one or more sensors that can capture sensor data describing an environment surrounding the client device 310. In one embodiment, the sensors include one or more cameras which can capture image data. The cameras capture image data describing a scene of the environment surrounding the client device 310 with a particular pose (the location and orientation of the camera within the environment). Cameras may use a variety of photo sensors with varying color capture ranges and varying capture rates. Similarly, the sensor assembly 312 may include cameras with a range of different lenses, such as a wide-angle lens or a telephoto lens. The cameras may be configured to capture single images or multiple images as frames of a video.

The sensor assembly 312 may also include additional sensors for collecting data regarding the environment surrounding the client device 310, such as movement sensors, LIDAR sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose, depth maps, etc.) or capture data (e.g., exposure length, shutter speed, focal length, capture time, etc.).

The local application module 314 provides a user with an interface to participate in the location-based application (e.g., a parallel-reality game). The application server 320 transmits application data over the network 370 to the client device 310 for use by the local application module 314 to provide a local version of the application to a user at locations remote from the application server. In one embodiment, the local application module 314 presents a user interface on a display of the client device 310 that depicts a virtual world (e.g., renders imagery of the virtual world) and allows a user to interact with the virtual world to perform various objectives (e.g., game objectives). In some embodiments, the local application module 314 presents images of the real world (e.g., captured by the sensor assembly 312) augmented with virtual elements from a virtual world of the application (e.g., game elements for a parallel reality game). In these embodiments, the local application module 314 may generate or adjust virtual content according to other information received from other components of the client device 310. For example, the local application module 314 may adjust a virtual object to be displayed on the user interface according to a depth map of the scene captured in the image data.

The local application module 314 can also control various other outputs to allow a user to interact with the application without requiring the user to view a display screen. For instance, the local application module 314 can control various audio, vibratory, or other notifications that allow the user to be aware of events in the application without looking at the display screen. The local application module 314 may also provides options for the user to interact with the application without looking at the display screen, such as via verbal commands or physical gestures captured by one or more cameras of the sensor assembly 312 (or a separate motion capture device).

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As user moves around with the client device 310 in the real world, the positioning module 316 tracks the position of the user and provides the player position information to the local application module 314. The local application module 314 updates the user position in the virtual world associated with the application based on the actual position of the user in the real world. Thus, a user can interact with the virtual world simply by carrying or transporting the client device 310 in the real world. In particular, the location of the user in the virtual world can correspond to the location of the user in the real world. The local application module 314 can provide user position information to the application server 320 over the network 370. In response, the application server 320 may enact various techniques to verify the location of the client device 310 (e.g., to prevent cheaters from spoofing their locations in embodiments where the application is a location-based game). It should be understood that location information associated with a user is used only if permission is granted after the user has been notified that location information of the user is to be accessed and how the location information is to be utilized in the context of the application (e.g., to update player position in the virtual world). In addition, any location information associated with users is stored and maintained in a manner to protect user privacy.

The localization module 318 provides an additional or alternative way to determine the location of the client device 310. In one embodiment, the localization module 318 receives a coarse location determined for the client device 310 by the positioning module 316 (e.g., GPS coordinates) and refines it by determining a pose of one or more cameras of the sensor assembly 312. The localization module 318 may use the coarse location generated by the positioning module 316 to select a 3D map of the environment surrounding the client device 310 and localize against the 3D map. The localization module 318 may obtain the 3D map from local storage or from the application server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by a camera assembly relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the local application module 314 to present virtual content overlaid on images of the real world (e.g., by displaying virtual elements in conjunction with a real-time feed from the camera on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The application server 320 includes one or more computing devices that provide application functionality to the client device 310. The application server 320 can include or be in communication with an application database 330. The application database 330 stores application data used in the location-based application to be served or provided to the client device 310 over the network 370.

In one embodiment, the application data stored in the application database 330 can include: (1) data associated with the virtual world (e.g., image data used to render the virtual world on a display device, geographic coordinates of locations in the virtual world, etc.); (2) data associated with users of the location-based application (e.g., user profiles including but not limited to user information, user experience level, user currency, current user positions in the virtual world/real world, user energy level in a game, user preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game or other application status (e.g., current number of players, current status of game objectives, player leaderboard, etc.); (7) data associated with user actions/input (e.g., current user positions, past user positions, user moves, user input, user queries, user communications, etc.); or (8) any other data used, related to, or obtained during implementation of the location-based application. The application data stored in the application database 330 can be populated either offline or in real time by system administrators or by data received from users (e.g., players), such as from a client device 310 over the network 370.

In one embodiment, the application server 320 is configured to receive requests for application data from a client device 310 (for instance via remote procedure calls (RPCs)) and to respond to those requests via the network 370. The application server 320 can encode application data in one or more data files and provide the data files to the client device 310. In addition, the application server 320 can be configured to receive application data (e.g., user positions, user actions, user input, etc.) from a client device 310 via the network 370. The client device 310 can be configured to periodically send user input and other updates to the application server 320, which the application server uses to update application data in the application database 330 to reflect any and all changed conditions for the application.

In the embodiment shown in FIG. 3, the application server 320 includes a universal application module 321, a commercial integration module 323, a data collection module 324, an event module 326, a mapping system 327, a usability mapping module 328, and a 3D map store 329. As mentioned above, the application server 320 interacts with an application database 330 that may be part of the application server or accessed remotely (e.g., the game database 330 may be a distributed database accessed via the network 370). In other embodiments, the application server 320 contains different or additional elements. In addition, the functions may be distributed among the elements in a different manner than described.

The universal application module 321 hosts an instance of the location-based application (e.g., a parallel-reality game) for a set of users (e.g., all users of the application) and acts as the authoritative source for the current status of the application for the set of users. As the host, the universal application module 321 generates application content for presentation to users (e.g., via their respective client devices 310). The universal application module 321 may access the application database 330 to retrieve or store application data when hosting the location-based application. The universal application module 321 may also receive application data from client devices 310 (e.g., depth information, user input, user position, user actions, landmark information, etc.) and incorporates the application data received into the overall location-based application for the entire set of users of the location-based application. The universal application module 321 can also manage the delivery of application data to the client device 310 over the network 370. In some embodiments, the universal application module 321 also governs security aspects of the interaction of the client device 310 with the location-based application, such as securing connections between the client device and the application server 320, establishing connections between various client devices, or verifying the location of the various client devices (e.g., to prevent players cheating by spoofing their location in a parallel-reality game).

The commercial integration module 323, if included, can manage the inclusion of various features within the location-based application that are linked with a commercial activity in the real world. For instance, the commercial integration module 323 can receive requests from external systems such as sponsors/advertisers, businesses, or other entities over the network 370 to include application features. The commercial integration module 323 can then arrange for the inclusion of these application features in the location-based application on confirming that the linked commercial activity has occurred. For example, if a business pays the provider of a parallel-reality game an agreed upon amount, a virtual object identifying the business may appear in the parallel-reality game at a virtual location corresponding to a real-world location of the business (e.g., a store or restaurant).

The data collection module 324 can manage the inclusion of various application features within the location-based application that are linked with a data collection activity in the real world. For instance, the data collection module 324 can modify application data stored in the application database 330 to include application features linked with data collection activity in a parallel-reality game. The data collection module 324 can also analyze data collected by users pursuant to the data collection activity and provide the data for access by various platforms.

The event module 326 manages user access to events in the location-based application. Although the term “event” is used for convenience, it should be appreciated that this term need not refer to a specific event at a specific location or time. Rather, it may refer to any provision of access-controlled application content where one or more access criteria are used to determine whether users may access that content. For example, such content may be part of a larger parallel-reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the application server 320 can provide the 3D map to client devices 310 that provide location data indicating they are within or near the geographic area covered by the 3D map.

The usability mapping module 328 generates a usability heatmap that describes where in a real-world environment users can safely experience AR content. The usability mapping module 328 aggregates data from one or more sources, such as user trajectories, semantic labels, object detections, map labels, user localizations, or other data sources. Based on the aggregated data, the usability mapping module 328 generates the usability heatmap. The usability mapping module 328 uses the usability heatmap to identify locations in which to provide AR content to users.

The network 370 can be any type of communications network, such as a local area network (e.g., an intranet), wide area network (e.g., the internet), or some combination thereof. The network can also include a direct connection between a client device 310 and the application server 320. In general, communication between the application server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

### Usability Mapping Module

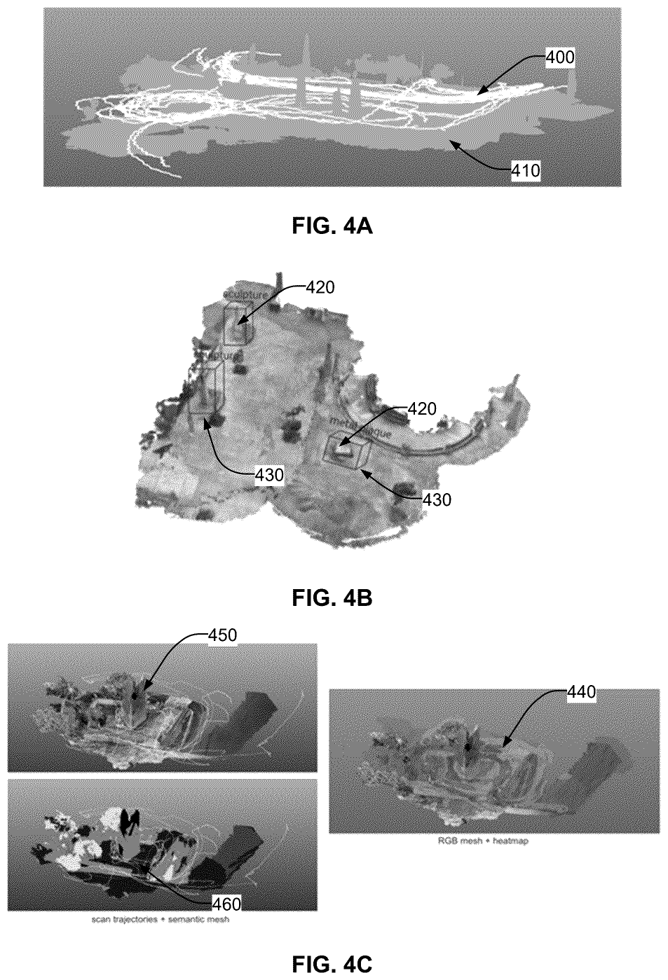

A usability mapping module 328 aggregates data from various data sources, including user location data, semantic labels, map labels, object detection data, and user localization data. For example, the usability mapping module 328 collects user location data from users of the game server. User location data is data describing a user's path as the user moves through a real-world environment. FIG. 4A shows example user trajectories 400 overlaid on a reconstruction of a real-world environment 410. The user location data describes the user's location over time, including the speed at which the user moves and the direction in which the user moves. For a period of time in which the user is not moving, for example if the user has stopped before crossing a street, the user location data captures the location where the user has stopped moving, the amount of time the user has stopped moving, and how the user holds a client device while they have stopped moving.

The usability mapping module 328 may collect user location data by using sensors on a client device that the user carries as they interact with the real-world environment. Sensors on the client device may be sensors that collect data regarding the real-world environment surrounding the device, such as movement sensors, accelerometers, gyroscopes, magnetometers, barometers, thermometers, light sensors, microphones, etc. A user's location data may also be determined by systems or techniques that locate the client device in the real-world environment. Example systems or techniques include a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, or triangulation or proximity to cellular towers or Wi-Fi hotspots.

The usability mapping module 328 accesses semantic labels describing the real-world environment. Semantic labels describe and provide additional contextual information to the real-world environment. For example, semantic labels may identify materials of the real-world environment (e.g., unnatural ground, pavement, sidewalk, road, brick, natural ground, grass, dirt, sand, water, lounge-able surface etc.) or game properties of the real-world environment (e.g., traversable by characters, suitable for certain in-game actions, etc.). The usability mapping module 328 may obtain semantic labels from a 3D map that represents the real-world environment, such as a point cloud or mesh. Each point in the 3D map may correspond to a location in the real-world environment and one or more semantic labels. For example, a location may correspond to a semantic label of “unnatural ground” and also correspond to semantic labels “pavement” and “road.” The usability mapping module 328 may obtain semantic labels from open vocabulary methods (e.g., using large language models) on gaussian splats representing the real-world environment.

The usability mapping module 328 may access labels for the real-world environment from geographic databases, such as OpenStreetMap (OSM). Geographic databases store information about a real-world environment, including labels that describe objects, points of interests, roads, and other map features. The usability mapping module 328 may use location information from the real-world environment (e.g., GPS data) to map labels in the geographic database to features in the real-world environment.

The usability mapping module 328 accesses data on objects detected in the real-world environment. Example objects may be people, statues, bicycles, cars, tables, benches, chairs, clocks, lampposts, or trees. The usability mapping module 328 may access detected object data from the 3D map of the real-world environment. In the 3D map, each detected object may be represented by a 3D bounding box surrounding the object. The 3D bounding box may be the same size of the detected object or larger than the detected object. The usability mapping module 328 may obtain data describing the class of the object (e.g., person, statue, etc.) as well as whether the object is permanent to the environment (e.g., a statue) or temporarily in the environment (e.g., a person). For objects that are temporarily in the environment, the usability mapping module 328 may obtain data on how the object moves, such as where the object moves in the environment and how fast it moves within the environment. For example, the usability mapping module 328 may obtain data describing cars moving fast in a certain region of the map corresponding to a road or parking lot. FIG. 4B is an example 3D map showing detected objects 420 surrounded by 3D bounding boxes 430.

The usability mapping module 328 computes usability scores for locations in the real-world environment based on user location data, semantic labels, map labels, or detected objects. A location's usability score represents how usable or suitable the location is for providing AR content, such as how safe it is for users to interact with AR content at the location, how accessible the location is to users (e.g., whether there is infrastructure for wheelchair access), whether users are allowed to interact with AR content at that location (e.g., whether the location is on private property, public property, government-owned, etc.), or how popular the location is for users (e.g., would users engage with AR content if placed at the location). An example location with a low usability score may be a busy road, as it is typically unsafe for users to interact with AR content while in a busy road. An example location with a high usability score may be a public park, as it is typically safe for users to interact with AR content in public parks.

In some embodiments, the usability mapping module 328 may compute the usability score of a location based on user location data. The usability mapping module 328 may compute a location's usability score based on how close the location is to a user location. For example, the usability mapping module 328 may compute the usability score based on the Euclidean distance between the location and points on the user location. As another example, the usability mapping module 328 may compute a usability score based on whether the location is within a threshold distance from a user location. The usability mapping module 328 may compute a high (or positive) score if a user location is within a threshold distance from the location and a low (or negative) score if no user location is within the threshold distance from the location. The usability mapping module 328 may assign a location with many nearby user trajectories a higher usability score than a location with only a few nearby user trajectories. In some embodiments, the usability mapping module 328 computes a bounding area based on user location data. The bounding area is the maximum area encapsulated by all trajectories. The usability mapping module 328 may compute the bounding area based on convex hull or ray casting methods. The usability mapping module 328 may compute the usability score of a location based on whether it lies inside or outside of a bounding area.

In some embodiments, the usability mapping module 328 may compute a location's usability score based on the semantic labels or map labels associated with the location. For example, the usability mapping module 328 may compute high usability scores for locations with semantic or map labels that suggest safe areas for interacting with AR content, such as “grass,” “sand” or “lounge-able surface.” Likewise, the AR gaming system may compute low usability scores for locations with semantic or map labels that suggest unsafe areas for interacting with AR content, such as “pavement,” “cars,” or “road.”

In some embodiments, the usability mapping module 328 may compute a location's usability score based on detected object data. The usability mapping module 328 may compute the usability score of a location based on the location's proximity to a detected object and the class of the detected object. For example, the usability mapping module 328 may compute a low usability score for locations near detected objects of the type “car” but may compute a high usability score for locations near detected objects of the type “people.” Similarly, the usability mapping module 328 may compute the usability score based on whether the detected objects near the location are permanent or moving. For example, the usability mapping module 328 may compute a low usability score for a location within the bounding box of a permanent object such as a building.

In some embodiments, the usability mapping module 328 computes a usability score based on a probabilistic framework that scores locations based on the frequency of a user traversing a particular location along with the likelihood of the location being associated with semantic labels corresponding to usable areas. The usability mapping module 328 computes a location score p(x) that represents the frequency that a user traverses to a location x. To compute p(x), the usability mapping module 328 models each point in the user location data as a Gaussian function. The usability mapping module 328 may compute p(x) according to Equation (EQ.) 1, where n₁ is the sum of the points modeled as Gaussian functions:

$$p ( x ) = log ( 1 + {n}_{1} ) \qquad ( EQ . 1 )$$

Modeling points as Gaussian functions allows the usability mapping module 328 to save computational resources. The number of points in the user location data is high. As the number of points in the user location data increases, the computational resources required to process the data exponentially increases. In some embodiments, the usability mapping module 328 converts points in the user location from a point representation to a binary image-based representation and uses a Gaussian function as a convolution filter. In doing so, the usability mapping module 328 speeds up convolutions for each point in the user location data and can obtain p(x) from this representation directly, avoiding additional compute for conversions.

The usability mapping module 328 additionally computes a semantic safe score q(x). The semantic safe score q(x) represents the likelihood that the location x is a safe location. The usability mapping module 328 may compute q(x) based on semantic probabilities for “safe” semantic labels, where safe semantic labels are semantic labels associated with safe locations, such as “natural ground,” “grass,” or “dirt.” The usability mapping module 328 may compute the semantic safe score q(x) according to EQ. 2, where n₂ is sum of semantic probabilities for safe semantic labels associated with the location:

$$q ( x ) = {n}_{2} \qquad ( EQ . 2 )$$

The usability mapping module 328 computes a semantic unsafe score r(x) that represents the likelihood that the location x is an unsafe location. The usability mapping module 328 may compute r(x) based on semantic probabilities for “unsafe” semantic labels of the location, where unsafe semantic labels are semantic labels associated with unsafe locations, such as “road” or “cars.” The usability mapping module 328 may compute the semantic unsafe score r(x) according to EQ. 3, where n₃ is the probability that the location is unsafe:

$$r ( x ) = {n}_{3} \qquad ( EQ . 3 )$$

The usability mapping module 328 computes the usability score of a location x as the weighted sum S(x) of the location score p(x), the semantic safe score q(x), and the semantic unsafe score r(x). Scores p(x), q(x), and r(x) are weighted by weights α, β, and γ, respectively. The weights may be tuned automatically, for example using optimization or machine learning techniques. The usability mapping module 328 may compute S(x) as shown in EQ. 4:

$$S ( x ) = α p ( x ) + β q ( x ) - γ r ( x ) \qquad ( EQ . 4 )$$

In some embodiments, the usability mapping module 328 computes the usability score by applying a SoftMax function to S(x). The SoftMax function converts S(x) to a probability distribution over all points x. Points x with high values in the probability distribution have high likelihood of being usable based on the user location and semantic data. In some embodiments, the AR gaming system may compute the usability score as the Kullback-Leibler (KL) divergence between the probability distribution of S(x) and an ideal probability distribution.

This described probability framework is extensible for other sources of data like map data, detected object data, and user localization data. The usability mapping module 328 may compute a weighted sum that is adjusted to reflect relative importance of each data source.

In some embodiments, the usability mapping module 328 may compute the usability score for a location using a machine learning model trained to receive a location as input and to output a usability score for the location. Training data for the machine learning model may include locations labelled based on one or more of user location data, semantic labels, map labels, object detection data, or user localization data. For example, a location with a semantic label of “road” may be labeled with a negative score while a location with a semantic label of “grass” may be labeled with a positive score.

The usability mapping module 328 generates a usability heatmap representing the usability of locations in a user's real-world environment for interacting with AR content. The usability heatmap may be geo-registered, aligning AR content with real world locations. For example, the usability mapping module 328 may generate a usability heatmap for each of a set of places of interest in the real world. The usability mapping module 328 generates the usability heatmap based on the usability scores for locations in the real-world environment. For example, the usability mapping module 328 may construct a heatmap by computing usability scores for locations on a 2D grid of a map of an area. The heatmap may be visualized such that locations with high usability scores are shown in pink and locations with low usability scores are shown in red. FIG. 4C shows an example usability heatmap 440 generated based on user location data 450 and semantic data 460.

In some embodiments, the usability mapping module 328 uses semantic data for a region containing a place of interest to update a usability heatmap for the place of interest. The usability mapping module 328 may generate usability heatmaps for a set of places of interest for which the game server has 3D models (e.g., meshes). These places of interest may be located within a geographic region for which the usability mapping module has semantic data describing features of the region. The usability mapping module 328 identify geographic features within the semantic data that overlap with the usability heatmap and may adjust usability scores within the heatmaps based on the identified geographic features within the semantic data. For example, the usability mapping module 328 may identify a road within the semantic data and identify a portion of the usability heatmap that the road overlaps. The usability mapping module 328 may adjust the usability scores of the portion of the heatmap that overlaps with the road to decrease the indicated usability of that portion of the heatmap.

The usability mapping module 328 identifies usable areas in the real-world environment based on the usability heatmap or usability scores for locations in the environment. The usability mapping module 328 may identify a useable area in the real-world environment as an area in which the usability scores of locations within the area exceed a threshold usability score. For example, the usability mapping module 328 may identify locations on a 2D map of usability scores with corresponding scores above some threshold as usable areas. In some embodiments, the usability mapping module 328 identifies a usable area as an area with an above-threshold usability score that also exceeds a size threshold. For example, if the usable area is to be used for presentation of AR content, the usable area must be large enough to host the AR content. In some embodiments, the usability mapping module 328 may override an identified usable area based on data associated with locations in the area. For example, the usability mapping module 328 may override an identified usable area that includes a road, even if the usability scores of locations within the area exceed the threshold usability score. Similarly, the usability mapping module 328 may override an identified unusable area based on data associated with locations in the area. For example, if an unusable area includes many user trajectories, the usability mapping module 328 may determine that the unusable area is usable.

In some embodiments, the usability mapping module 328 provides users with AR content in the identified usable areas. When a user approaches a usable area, the usability mapping module 328 may present the AR content for display through an application on the user's client device. The usability mapping module 328 may use the usability heatmap to increase knowledge and discoverability of identified usable locations. For example, the usability mapping module 328 may provide directions to guide the user to usable areas or areas with AR content. In some embodiments, the usability mapping module 328 may detect when a user leaves a usable area and issue a warning to the user.

In some embodiments, the usability mapping module 328 uses the usability heatmap to identify locations in the real-world environment that are lacking data (e.g., lacking semantic labels, lacking user location data). This may inform further efforts to collect data in a location (e.g., by requesting or instructing a player to move to or nearby a location). Additionally, the usability mapping module 328 may use conflicts with usability scores to identify areas where it may have incorrect or incomplete data describing a location. For example, the usability mapping module 328 may generate low usability scores for roads because roads tend to have moving cars. However, the usability mapping module 328 may have location data that indicates that many players are located within the road. The usability mapping module 328 may determine that it has incorrect data about the road (e.g., that the area is not actually a road) or incomplete data (e.g., that the road has been blocked to cars so that it only allows for foot traffic).

In some embodiments, the usability mapping module 328 generates overall usability scores for places of interest. An overall usability score represents the usability scores within the generated usability heatmaps of the places of interest. For example, to compute an overall usability score for a place of interest, the usability mapping module may compute an average or weighted average of the usability scores in the usability heat map of a place of interest. The usability mapping module 328 may receive requests from third-party systems for 3D models of places of interest and may sort or rank the models based on the overall usability scores of the 3D models. The usability mapping module 328 may then provide the sorted list of 3D models to the third-party system.

In some embodiments, the usability scores for usability heatmaps (or an overall score for a place of interest) are generated based on context data for the geographic regions around the geographic areas for which the usability heatmaps are generated. The usability mapping module 328 may use the context data (e.g., semantically labeled geographic data) to compute an accessibility score for the geographic area. This accessibility score may represent how accessible the geographic area is from outside the area. For example, the usability mapping module may identify a road or pathway that leads into the geographic area and may generate an increased accessibility score for the geographic area accordingly.

### Example Methods

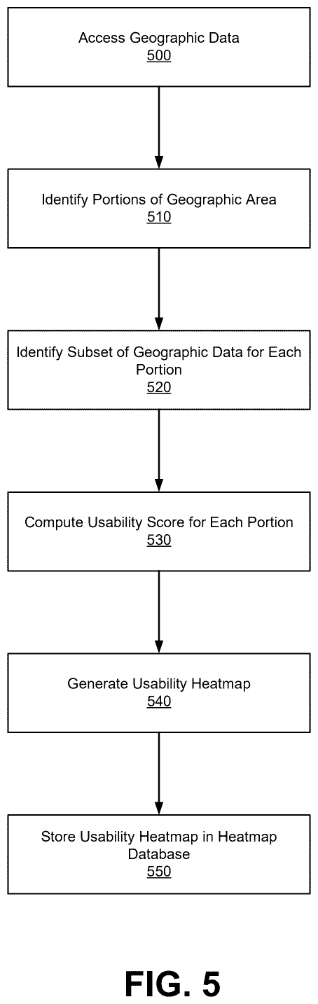

FIG. 5 is a flowchart describing an example method of generating usability maps for geographic areas, according to one embodiment. The steps of FIG. 5 are illustrated from the perspective of an online system (e.g., an application server 320) performing the method. However, some or all of the steps may be performed by other entities or components. In addition, some embodiments may perform the steps in parallel, perform the steps in different orders, or perform different steps.

An online system accesses 500 geographic data describing a geographic area for which the online system provides AR content services. For example, the online system may provide AR content around places of interest in the real world by storing 3D models of the places of interest and by generating AR content based on sensor data captured by client devices and the 3D models. The geographic data may include user location data (e.g., user trajectory data), semantic labels (e.g., generated by semantic segmentation of 3D models of geographic areas), map labels, object detection data, and user localization data.

The online system generates a usability heatmap for the geographic area based on the geographic data. To generate the usability heatmap, the online system identifies 510 a set of portions of the geographic area. For example, these portions may be a grid of sub-areas within the geographic area. The online system identifies 520 subsets of the geographic data for each of the portions of the geographic area and computes 530 a usability score for each of the portions. For example, the online system may compute a frequency with which users are present within each of the portions and compute a usability score for each of the portions based on the corresponding frequencies.

The online system generates 540 a usability heatmap based on the computed usability scores for the portions of the geographic area and stores 550 the heatmap in a heatmap database that stores usability heatmaps for different geographic areas. The online system may use the heatmaps in the database to generate AR content when requested by client devices. For example, the usability heatmaps may align with 3D models (e.g., meshes) of geographic areas and the online system may use the usability heatmaps to place AR content within the 3D models. For example, the online system may require a threshold usability score for portions of the usability heatmap for AR content to be placed within the portions.

### Example Computing System

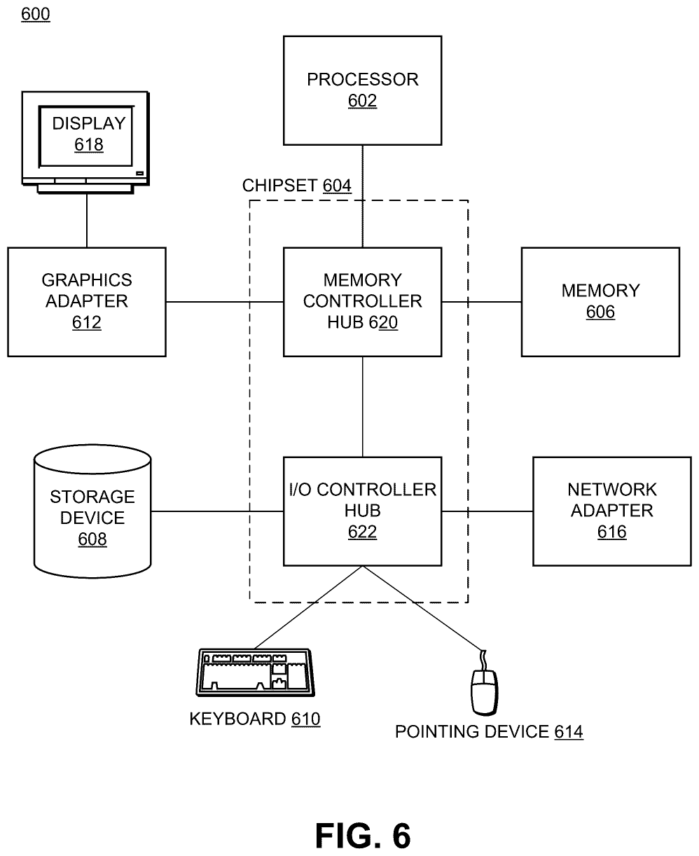

FIG. 6 is a block diagram of an example computer 600 suitable for use as a client device 310 or an application server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIG. 3 can vary depending upon the embodiment and the processing power required by the entity. For example, the application server 320 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
accessing, by an online system, geographic data for a geographic area, wherein the geographic data describes features of the geographic area;
generating a usability heatmap for the geographic area based on the geographic data, wherein generating the usability heatmap comprises:
identifying a plurality of portions of the geographic area;
identifying a subset of the geographic data corresponding to each of the plurality of portions of the geographic area;
computing a usability score for each of the plurality of portions of the geographic area based on the corresponding subset of the geographic data for each of the portions; and
generating the usability heatmap based on the computed usability scores for the plurality of portions; and
storing the usability heatmap in association with the geographic area in a heatmap database, wherein the heatmap database stores a plurality of usability heatmaps in association with a plurality of geographic areas.

2. The method of claim 1, wherein the geographic data comprises location data captured by location sensors of client devices associated with users of the online system, wherein the location data describes locations of the client devices over time.

3. The method of claim 2, wherein the geographic data comprises trajectory data describing trajectories of client devices within the geographic area over time.

4. The method of claim 1, wherein the geographic data comprises semantic data comprising semantically segmented portions of the geographic area.

5. The method of claim 4, wherein generating the usability heatmap for the geographic area comprises:
generating an initial usability heatmap comprising a set of initial usability scores;
accessing a semantic map for a geographic region comprising the geographic area, wherein the semantic map comprises semantically segmented portions of the geographic region;
identifying one or more portions of the geographic region that overlap with the geographic area; and
updating the set of initial usability scores based on the identified one or more portions of the geographic region.

6. The method of claim 1, wherein the geographic data comprises image data comprising images depicting objects within the geographic area.

7. The method of claim 6, wherein computing a usability score for a portion of the geographic area comprises:
detecting an object in the image data; and
computing the usability score for the portion based on the detected object.

8. The method of claim 1, further comprising:
computing an overall usability score for each of the plurality of geographic areas based on the corresponding usability heatmap of the geographic area.

9. The method of claim 1, wherein computing a usability score for a portion of the geographic area comprises:
computing a frequency of a user being located within the portion based on the geographic data.

10. The method of claim 1, further comprising:
receiving, at the online system, a request for AR content from a client device associated with a user of the online system, wherein the request comprises location data describing a location of the client device;
identifying a geographic area of the plurality of geographic area containing the location of the client device;
identifying a usability heatmap in the heatmap database corresponding to the identified geographic area;
generating AR content based on the identified usability heatmap; and
transmitting the AR content to the client device for display to the user.

11. A non-transitory computer-readable medium storing instructions that, when executed by a computer system, cause the computer system to perform operations comprising:
accessing, by an online system, geographic data for a geographic area, wherein the geographic data describes features of the geographic area;
generating a usability heatmap for the geographic area based on the geographic data, wherein generating the usability heatmap comprises:
identifying a plurality of portions of the geographic area;
identifying a subset of the geographic data corresponding to each of the plurality of portions of the geographic area;
computing a usability score for each of the plurality of portions of the geographic area based on the corresponding subset of the geographic data for each of the portions; and
generating the usability heatmap based on the computed usability scores for the plurality of portions; and
storing the usability heatmap in association with the geographic area in a heatmap database, wherein the heatmap database stores a plurality of usability heatmaps in association with a plurality of geographic areas.

12. The computer-readable medium of claim 11, wherein the geographic data comprises location data captured by location sensors of client devices associated with users of the online system, wherein the location data describes locations of the client devices over time.

13. The computer-readable medium of claim 12, wherein the geographic data comprises trajectory data describing trajectories of client devices within the geographic area over time.

14. The computer-readable medium of claim 11, wherein the geographic data comprises semantic data comprising semantically segmented portions of the geographic area.

15. The computer-readable medium of claim 14, wherein generating the usability heatmap for the geographic area comprises:
generating an initial usability heatmap comprising a set of initial usability scores;
accessing a semantic map for a geographic region comprising the geographic area, wherein the semantic map comprises semantically segmented portions of the geographic region;
identifying one or more portions of the geographic region that overlap with the geographic area; and
updating the set of initial usability scores based on the identified one or more portions of the geographic region.

16. The computer-readable medium of claim 11, wherein the geographic data comprises image data comprising images depicting objects within the geographic area.

17. The computer-readable medium of claim 16, wherein computing a usability score for a portion of the geographic area comprises:
detecting an object in the image data; and
computing the usability score for the portion based on the detected object.

18. The computer-readable medium of claim 11, the operations further comprising:
computing an overall usability score for each of the plurality of geographic areas based on the corresponding usability heatmap of the geographic area.

19. The computer-readable medium of claim 11, wherein computing a usability score for a portion of the geographic area comprises:
computing a frequency of a user being located within the portion based on the geographic data.

20. The computer-readable medium of claim 11, the operations further comprising:
receiving, at the online system, a request for AR content from a client device associated with a user of the online system, wherein the request comprises location data describing a location of the client device;
identifying a geographic area of the plurality of geographic area containing the location of the client device;
identifying a usability heatmap in the heatmap database corresponding to the identified geographic area;
generating AR content based on the identified usability heatmap; and
transmitting the AR content to the client device for display to the user.
